(19) United States
(12) Patent Application Publication
(10) Pub. No.: US 2017/0158829 A1
(43) Pub. Date: Jun. 8, 2017

(54) TWO-PACK TYPE EPOXY RESIN COMPOSITION FOR FIBER-REINFORCED COMPOSITE MATERIAL, AND FIBER-REINFORCED COMPOSITE MATERIAL

(71) Applicant: Toray Industries, Inc., Tokyo (JP)

(72) Inventors: Kazunori Hondo, Nagoya-shi (JP); Nobuyuki Tomioka, Nagoya-shi (JP)

(21) Appl. No.: 15/327,099

(22) PCT Filed: Jul. 3, 2015
(86) PCT No.: PCT/JP2015/069224

§ 371 Date: Jan. 18, 2017

(30) Foreign Application Priority Data
Jul. 31, 2014 (JP) 2014-155752

(51) Int. Cl. C08J 5/04; C08G 59/32; C08G 59/50; C08J 5/24

(52) U.S. Cl. CPC C08J 5/04; C08J 5/042; C08J 5/24; C08G 59/3227; C08G 59/5033; C08J 2363/00

(57) ABSTRACT

A two-pack type epoxy resin composition for a fiber-reinforced composite material, includes the following components (A) to (C), the epoxy resin composition having: an epoxy base resin liquid containing 30 mass % or more and 100 mass % or less of a component (A) and a curing agent liquid containing a component (B). The component (A) is a glycidylamine type epoxy resin; the component (B) is an aromatic amine; and the component (C) is a compound having at least two aromatic rings each of which has a phenolic hydroxy group.

### TECHNICAL FIELD

This disclosure relates to a two-pack type epoxy resin composition for a fiber-reinforced composite material which is suitably used as a fiber-reinforced composite material for members for airplanes, members for spacecraft, members for automobiles and the like, as well as a fiber-reinforced composite material produced using the two-pack type epoxy resin composition.

### BACKGROUND

Applications of a fiber-reinforced composite material comprising a reinforcing fiber and a matrix resin have been spreading in fields including sports and general industries, particularly aerospace because the material enables material designs that make use of the advantages of reinforcing fibers and matrix resins.

As the reinforcing fiber, a glass fiber, an aramid fiber, a carbon fiber, a boron fiber or the like is used. As the matrix resin, both a thermosetting resin and a thermoplastic resin can be used, though a thermosetting resin is more frequently used because of its ease of impregnation into a reinforcing fiber. As the thermosetting resin, an epoxy resin, an unsaturated polyester resin, a vinyl ester resin, a phenolic resin, a bismaleimide resin, a cyanate resin or the like is used.

As a method of molding a fiber-reinforced composite material, a method such as a prepreg method, a hand lay-up method, a filament winding method, a pultrusion method and an RTM (Resin Transfer Molding) method is employed. A prepreg method is a method that results in a molded product by impregnating a reinforcing fiber with an epoxy resin composition to obtain prepregs, laminating the prepregs such that the prepregs have a desired shape, and heating the laminated prepregs. However, though the prepreg method is suitable for producing a fiber-reinforced composite material with high material strength required for application in structure members for airplanes, automobiles and the like, the method requires a large number of processes including the process of preparing prepregs and that of laminating the prepregs and, therefore, the method only enables a small scale production and is not suitable for a large scale production, that is, the method has a problem of low productivity. On the other hand, an RTM method is a method of producing a molded product comprising putting a reinforcing fiber into a molding mold beforehand, injecting a liquid epoxy resin composition into the molding mold, impregnating the reinforcing fiber with the liquid epoxy resin composition, and conducting heating and curing to produce the molded product. By employing the RTM method, a fiber-reinforced composite material can be molded in a short period of time by preparing a molding mold without producing prepregs, and there is a further advantage that a fiber-reinforced composite material with a complex shape can be easily molded.

When employing an RTM method, a hand lay-up method, a filament winding method and a pultrusion method, a two-pack type epoxy resin composition is often used from the viewpoint of molding processability. A two-pack type epoxy resin composition refers to an epoxy resin composition constituted of an epoxy base resin liquid containing an epoxy resin as a main component, and a curing agent liquid containing a curing agent as a main component, and is obtained by mixing two liquids which are the epoxy base resin liquid and the curing agent liquid immediately before use. On the other hand, an epoxy resin composition containing all the components including a base resin and a curing agent as one mixture is referred to as a one-pack type epoxy resin composition.

In a one-pack type epoxy resin composition, the curing reaction proceeds even during a storage period of the composition and, therefore, frozen storage is required. In addition, in a one-pack type epoxy resin composition, an agent having a solid form with low reactivity is frequently selected as a component of a curing agent and, therefore, the one-pack type epoxy resin composition should be pushed with high pressure by using a press roll and the like so that a reinforcing fiber is impregnated with the one-pack type epoxy resin composition. In a two-pack type epoxy resin composition, a liquid mixture having low viscosity can be obtained after mixing a base resin liquid and a curing agent liquid since an epoxy base resin liquid and the curing agent liquid are each in a liquid form and, therefore, a reinforcing fiber can be easily impregnated with the epoxy resin composition. In addition, the two-pack type epoxy resin composition can be stored for a long period of time without any particular limitations on the storage conditions since the epoxy base resin liquid and the curing agent liquid are stored separately.

For example, to produce a fiber-reinforced composite material with high efficiency by an RTM method, reduction in the curing time of a resin is essential. In addition, in most cases, a fiber-reinforced composite material used in the fields of automobiles and airplanes requires heat resistance. The modulus of rigidity of a cured product of an epoxy resin drastically decreases at a temperature equal to or higher than the glass transition temperature and, thereby mechanical properties of the fiber-reinforced composite material containing the cure product also decreases. Accordingly, the glass transition temperature of a cured product of a resin is considered to be an indicator of heat resistance of a fiber-reinforced composite material, and the improvement of the glass transition temperature is desired.

To solve these problems, an epoxy resin composition for an RTM method having high-speed curability containing 4-tert-butylcatechol as a curing accelerator is disclosed in Japanese Patent No. 4396274 A. However, the technique disclosed in JP '274 cannot enable the achievement of sufficient high-speed curability. Further, there have been some cases where problems in surface quality have occurred, for example, voids have appeared in the resulting fiber-reinforced composite material by volatilization of a part of 4-tert-butylcatechol during heat curing.

In addition, an epoxy resin composition having high-speed curability for an RTM method containing an acid ester as a curing accelerator is disclosed in Japanese Translation of PCT Application No. H09-507262. However, by employing the technique disclosed in JP '274, heat resistance of a cured product of a resin decreases markedly, which is caused by addition of the acid ester. Further, also in this case, there have been some cases where problems in surface quality have occurred, for example, voids have appeared in the resulting fiber-reinforced composite material by volatilization of a part of the acid ester during the heat curing.

As described above, a two-pack type epoxy resin composition for a fiber-reinforced composite material has not existed until now which is capable of producing a cured product of a resin that has high-speed curability in a necessary and sufficient manner to realize a high level of productivity of a fiber-reinforced composite material as well as high heat resistance required for application in structure members for airplanes, automobiles and the like, and which is capable of producing a cured product of a resin with high quality without causing a void during the heat curing.

It could be helpful to provide a two-pack type epoxy resin composition for a fiber-reinforced composite material capable of producing a cured product of a resin having high-speed curability as well as high heat resistance and is also capable of producing a fiber-reinforced composite material with high quality, without causing voids during heat curing.

### SUMMARY

We thus provide a two-pack type epoxy resin composition for the fiber-reinforced composite material comprising components (A) to (C) below, the epoxy resin composition comprising:

an epoxy base resin liquid which comprises 30 mass % or more and 100 mass % or less of a component (A); and

a curing agent liquid which comprises a component (B),

wherein,

the component (A) is a glycidylamine type epoxy resin;

the component (B) is an aromatic amine; and

the component (C) is a compound having at least two aromatic rings each of which has a phenolic hydroxy group.

In addition, our fiber-reinforced composite material has the following constituents. That is, the fiber-reinforced composite material is obtained by combining the two-pack type epoxy resin composition for the fiber-reinforced composite material with a reinforcing fiber and curing them.

It is thus possible to provide a two-pack type epoxy resin composition for a fiber-reinforced composite material capable of producing a cured product of a resin having high-speed curability as well as high heat resistance and is also capable of producing a fiber-reinforced composite material with high quality without causing voids during heat curing. Accordingly, it is possible to provide a fiber-reinforced composite material at high productivity.

### DETAILED DESCRIPTION

Hereinbelow, preferred examples will be described.

First, a two-pack type epoxy resin composition for a fiber-reinforced composite material is described.

The two-pack type epoxy resin composition for the fiber-reinforced composite material comprises the following components (A) to (C), the epoxy resin composition comprising:

an epoxy base resin liquid comprising 30 mass % or more and 100 mass % or less of a component (A); and

a curing agent liquid comprising a component (B);

wherein,

the component (A) is a glycidylamine type epoxy resin;

the component (B) is an aromatic amine; and

the component (C) is a compound having at least two aromatic rings each of which has a phenolic hydroxy group.

The component (A) is a glycidylamine type epoxy resin.

Specific examples of the component (A) include polyfunctional glycidylamine type epoxy resins such as N,N,N′,N′-tetraglycidyldiaminodiphenylmethane, triglycidylaminophenol, N,N-diglycidylaniline, N,N,N′,N′-tetraglycidylxylenediamine, and derivatives and isomers, hydrogenated products thereof such as alkyl-substituted products, aryl-substituted products, alkoxy-substituted products, aryloxy-substituted products and halogen-substituted products thereof. These epoxy resins contribute to an increase in the crosslinking densities of cured products of resins and, therefore, the use of these epoxy resins makes it possible to improve heat resistance of fiber-reinforced composite materials. Among the above-described polyfunctional glycidylamine type epoxy resins, a tri- or higher functional glycidylamine type epoxy resin is preferable, and a tri- or higher functional glycidylamine-type aromatic epoxy resin is particularly preferable. The term “polyfunctional” refers to having at least two glycidyl groups, and the phrase “trifunctional” refers to having 3 glycidyl groups.

Examples of the tri- or higher functional glycidylamine type epoxy resin to be preferably used include N,N,N′,N′-tetraglycidyldiaminodiphenylmethane and triglycidylaminophenol as well as derivatives and isomers thereof. Examples of N,N,N′,N′-tetraglycidyldiaminodiphenylmethane as well as derivatives and isomers thereof may include N,N,N′,N′-tetraglycidyl-4,4′-diaminodiphenylmethane, N,N,N′,N′-tetraglycidyl-3,3′-dimethyl-4,4′-diaminodiphenylmethane, N,N,N′,N′-tetraglycidyl-3,3′-diethyl-4,4′-diaminodiphenylmethane, N,N,N′,N′-tetraglycidyl-3,3′-diisopropyl-4,4′-diaminodiphenylmethane, N,N,N′,N′-tetraglycidyl-3,3′-di-t-butyl-4,4′-diaminodiphenylmethane, N,N,N′,N′-tetraglycidyl-3,3′-dimethyl-5,5′-diethyl-4,4′-diaminodiphenylmethane, N,N,N′,N′-tetraglycidyl-3,3′-diisopropyl-5,5′-diethyl-4,4′-diaminodiphenylmethane, N,N,N′,N′-tetraglycidyl-3,3′-diisopropyl-5,5′-dimethyl-4,4′-diaminodiphenylmethane, N,N,N′,N′-tetraglycidyl-3,3′-di-t-butyl-5,5′-diethyl-4,4′-diaminodiphenylmethane, N,N,N′,N′-tetraglycidyl-3,3′-di-t-butyl-5,5′-dimethyl-4,4′-diaminodiphenylmethane, N,N,N′,N′-tetraglycidyl-3,3′,5,5′-tetramethyl-4,4′-diaminodiphenylmethane, N,N,N′,N′-tetraglycidyl-3,3′,5,5′-tetraethyl-4,4′-diaminodiphenylmethane, N,N,N′,N′-tetraglycidyl-3,3′,5,5′-tetraisopropyl-4,4′-diaminodiphenylmethane, N,N,N′,N′-tetraglycidyl-3,3′,5,5′-tetra-t-butyl-4,4′-diaminodiphenylmethane, N,N,N′,N′-tetraglycidyl-3,3′-dichloro-4,4′-diaminodiphenylmethane, N,N,N′,N′-tetraglycidyl-3,3′-dibromo-4,4′-diaminodiphenylmethane and the like. In addition, examples of triglycidylaminophenol as well as derivatives and isomers thereof include N,N,O-triglycidyl-p-aminophenol, N,N,O-triglycidyl-m-aminophenol and the like.

The glycidylamine type epoxy resin has an effect of increasing heat resistance of cured products of resins, and it is necessary that the content ratio of the glycidylamine type epoxy resin in the epoxy base resin liquid is 30 mass % or more and 100 mass % or less based on the total mass of the epoxy base resin liquid, and it is preferable that the content ratio is 50 mass % or more. When the content ratio of the glycidylamine type epoxy resin in the epoxy base resin liquid is 30 mass % or more, the compressive strength of the fiber-reinforced composite material increases, and the heat resistance of the cured product of the resin improves.

In addition, at least one kind of epoxy resin other than the component (A) selected from a bisphenol-type epoxy resin, a phenol novolac type epoxy resin, a cresol novolac type epoxy resin, a resorcinol type epoxy resin, a phenolaralkyl type epoxy resin, a naphthol aralkyl type epoxy resin, a dicyclopentadiene type epoxy resin, an epoxy resin having a biphenyl skeleton, an isocyanate-modified epoxy resin, a tetraphenylethane type epoxy resin, a triphenylmethane type epoxy resin and the like, may be contained in the epoxy base resin liquid provided that the content of the epoxy resin other than the component (A) is 70 mass % or less based on the total mass of the epoxy base resin liquid.

More specific examples of the epoxy resin other than the component (A) include bisphenol A diglycidyl ether, bisphenol F diglycidyl ether, tetrabromobisphenol A diglycidyl ether, bisphenol AD diglycidyl ether, 2,2′,6,6′-tetramethyl-4,4′-biphenoldiglycidyl ether, a diglycidyl ether of 9,9-bis(4-hydroxyphenyl)fluorene, a triglycidyl ether of tris(p-hydroxyphenyl)methane, a tetraglycidyl ether of tetrakis(p-hydroxyphenyl)ethane, phenol novolac glycidyl ether, cresol novolac glycidyl ether, a glycidyl ether of a condensation product of phenol and dicyclopentadiene, a glycidyl ether of a biphenyl aralkyl resin, triglycidyl isocyanurate, 5-ethyl-1,3-diglycidyl-5-methylhydantoin, an oxazolidone type epoxy resin obtained by an addition reaction of bisphenol A diglycidyl ether and tolylene isocyanate, a phenolaralkyl type epoxy resin and the like. Among them, the bisphenol-type epoxy resin is preferably used because the bisphenol-type epoxy resin contributes to the balance between toughness and heat resistance of the cured product of the resin in an excellent manner, and a liquid bisphenol-type epoxy resin is particularly preferably used as the epoxy resin other than the component (A) contained in the epoxy base resin liquid because the liquid bisphenol-type epoxy resin contributes to excellent impregnability of the resin into a reinforcing fiber.

The phrase “bisphenol-type epoxy resin” refers to a resin made from a bisphenol compound in which two phenolic hydroxy groups are glycidylated, and examples of the bisphenol-type epoxy resin include a bisphenol A-type epoxy resin, a bisphenol F-type epoxy resin, a bisphenol AD-type epoxy resin, a bisphenol S-type epoxy resin as well as halogen-substituted products, alkyl-substituted products, hydrogenated products of these bisphenol-type epoxy resins, and the like. In addition, as a bisphenol-type epoxy resin, not only a high molecular weight product composed of a single monomer, but also a high molecular weight product having a plurality of repeating units can be suitably used. When a bisphenol-type epoxy resin is contained, the content ratio of the bisphenol-type epoxy resin in the epoxy base resin liquid based on the total mass of the epoxy base resin liquid is preferably 20 mass % or more and 70 mass % or less, and is more preferably 20 mass % or more and 50 mass % or less from the viewpoint of the balance between toughness and heat resistance of the cured product of the resin.

The component (B) is an aromatic amine. An aromatic amine to be used is not particularly limited as long as the aromatic amine is an aromatic amine compound which may be used as a curing agent for an epoxy resin, but it is preferable to use a liquid aromatic amine because it is necessary for a two-pack type epoxy resin composition to contain a curing agent liquid as a liquid. In addition, when a solid aromatic amine is used as an aromatic amine, it is preferable to prepare a mixture of a liquid amine and the solid aromatic amine by adding the liquid amine to the curing agent liquid, and it is particularly preferable to prepare a mixture of a liquid aromatic amine and the solid aromatic amine from the viewpoint of obtaining a cured product of a resin having high heat resistance and high mechanical properties. In other words, in any case, the curing agent liquid contains a liquid amine. The term “liquid” refers to a state where a viscosity at 25° C. is 1000 Pa·s or lower, and the term “solid” refers to a state where fluidability is not exhibited at 25° C. or a state where extremely low fluidability is exhibited at 25° C. Specifically, “solid” refers to a state where a viscosity at 25° C. is higher than 1000 Pa·s. Viscosity is measured according to “Methods for measuring viscosity by a cone/plate rotational viscometer” prescribed in JIS Z8803 (1991) by using an E-type viscometer equipped with a standard cone rotor (1° 34′×R24) (for example, TVE-30H manufactured by Tokimec Inc.).

Specific examples of the liquid amine include those which are classified into aliphatic amines such as ethylenediamine, diethylenetriamine, triethylenetetramine, tetraethylenepentamine and 2-methyl-1,5-diaminopentane, those which are classified into alicyclic amines such as methylenebis(cyclohexylamine), 4,4′-methylenebis(2-methylcyclohexylamine), an aminocyclohexane alkyl amine and isophorone diamine as well as those which are classified into aromatic amines such as diethyltoluenediamines such as 2,2′-diethyldiaminodiphenylmethane, 2,4-diethyl-6-methyl-m-phenylenediamine, 4,6-diethyl-2-methyl-m-phenylenediamine and 4,6-diethyl-m-phenylenediamine, 4,4′-methylenebis(N-methylaniline), 4,4′-methylenebis(N-ethylaniline), 4,4′-methylenebis(N-sec-butylaniline) and N,N′-di-sec-butyl-p-phenylenediamine. The use of the liquid aromatic amine is preferable because a cured product of an epoxy resin having high glass transition temperature and high elastic modulus is obtained. Examples of commercially available products of liquid aromatic amines include “jERCURE” (registered trademark) W manufactured by Mitsubishi Chemical Corporation and “Aradur” (registered trademark) 5200 US manufactured by Huntsman Japan KK.

In addition, specific examples of the solid aromatic amine include 4,4′-diaminodiphenylmethane, 3,3′-diaminodiphenyl sulfone, 4,4′-diaminodiphenyl sulfone, 3,3′-diisopropyl-4,4′-diaminodiphenylmethane, 3,3′-di-t-butyl-4,4′-diaminodiphenylmethane, 3,3′-diethyl-5,5′-dimethyl-4,4′-diaminodiphenylm ethane, 3,3′-di-t-butyl-5,5′-dimethyl-4,4′-diaminodiphenyl-methane, 3,3′,5,5′-tetraethyl-4,4′-diaminodiphenylmethane, 3,3′-diisopropyl-5,5′-diethyl-4,4′-diaminodiphenylmethane, 3,3′-di-t-butyl-5,5′-diethyl-4,4′-diaminodiphenylmethane, 3,3′-di-t-butyl-5,5′-diisopropyl-4,4′-diaminodiphenylmethane, 3,3′,5,5′-tetra-t-butyl-4,4′-diaminodiphenylmethane and the like.

The curing agent liquid can be obtained by dissolving, as needed, other components in only a liquid aromatic amine or in a mixture of a liquid amine and a solid aromatic amine, and liquidifying all the components.

When a mixture of a liquid amine and a solid aromatic amine is used as a curing agent liquid, the content ratio of the solid aromatic amine is not particularly limited as long as the resulting curing agent liquid is a liquid, but the solid aromatic amine is preferably 80 mass % or less and is more preferably 20 mass % or more and 80 mass % or less based on the total amount of amines from the viewpoint of the balance between impregnability into a reinforcing fiber and mechanical properties of a cured product of a resin.

With regard to the content ratio of the curing agent liquid, a ratio of the total number of active hydrogens (H) in the entire curing agent in the curing agent liquid to the total number of epoxy groups (E) in the entire epoxy resin in the epoxy base resin liquid, that is, H/E is preferably 0.8 or more and 1.1 or less, more preferably 0.85 or more and 1.05 or less, and even more preferably 0.9 or more and 1 or less. If H/E is less than 0.8, the reaction ratio of a cured product of a resin may be insufficient and heat resistance, material strength and the like decrease. On the other hand, if H/E is more than 1.1, the impact resistance of a fiber-reinforced composite material may be insufficient since plastic deformation capacity is poor although the reaction ratio of a cured product of a resin is sufficient. When a curing agent liquid contains only the component (B) as a curing agent, H is equal to the total number of active hydrogens in the component (B), and therefore, the content ratio of the component (B) is represented by H/E.

The component (C) is a compound having at least two aromatic rings each of which has a phenolic hydroxy group. In other words, a compound of the component (C) has hydroxyphenyl structures. By making an epoxy resin composition contain the component (C), not only high heat resistance of the resulting cured product of the resin can be secured, but also a high curing speed is enabled, and the problem of volatilization during the curing process does not occur.

Specific examples of the component (C) include Bisphenol A, Bisphenol S, Bisphenol F, biphenol, bisphenolfluorene, 2,2-bis(4-hydroxy-3,5-dimethylphenyl)propane, 4,4′-methylenebis(2,6-dimethylphenol), 4,4′-methylenebis(2,6-di-tert-butylphenol), biphenol, bisphenolfluorene, biscresolfluorene, phenol novolac, cresol novolac and the like. In particular, the component (C) is preferably a bisphenol compound containing at least two phenolic hydroxy groups.

In addition, from the viewpoint of high-speed curability and viscosity stability, an acid dissociation constant (pKa) of the component (C) is preferably 7 or more and 9.8 or less, and is particularly preferably 7 or more and 9 or less. The acid dissociation constant (pKa) of the component (C) is found according to the equation: pKa=−log Ka, by measuring Ka=[H₃O⁺][B⁻]/[BH] (wherein, [H₃O⁺] represents the hydrogen ion concentration, [BH] represents the concentration of the component (C), and [B⁻] represents the concentration of the conjugate base which is obtained by proton release from the component (C)) under the condition in dilute aqueous solution. Examples of the method of measuring pKa include a method which comprises measuring the hydrogen ion concentration by using a pH meter and calculating pKa from the concentration of the substance of interest and the hydrogen ion concentration.

A single compound or a plurality of compounds may be used as the component (C). When the single compound is used, it is preferable that the acid dissociation constant (pKa) of the compound is in the above-described range, and when the plurality of compounds are used, it is preferable that the acid dissociation constant (pKa) of at least one compound among the plurality of compounds is in the above-described range.

If using only a compound(s) having a acid dissociation constant (pKa) of less than 7 as the component (C), the viscosity stability of the epoxy resin composition obtained after mixing an epoxy base resin liquid and a curing agent liquid tends to markedly decrease and tends to thicken and, therefore, impregnability of the resin into a base tends to be impaired. On the other hand, if using only a compound(s) having an acid dissociation constant (pKa) of more than 9.8, a sufficient effect of accelerating the curing may not be achieved.

The component (C) is normally a low molecular weight compound from the viewpoint of ease of preparation and viscosity stability at a low temperature. The phrase “low molecular weight compound” refers to a compound having a molecular weight of 1000 or lower.

The content ratio of the component (C) based on 100 parts by mass of the total of the epoxy resin contained in the epoxy base resin liquid is preferably 1 part by mass or more and 20 parts by mass or less, is more preferably 1 part by mass or more and 15 parts by mass or less, and is particularly preferably 1 part by mass or more and 10 parts by mass or less. If the content ratio of the component (C) is less than 1 part by mass, a sufficient effect of accelerating the curing cannot be achieved and, on the other hand, if the content ratio of the component (C) is more than 20 parts by mass, heat resistance of cured products of the resins may markedly decrease.

The epoxy resin composition may contain a plasticizer, a dye, a pigment, an inorganic filler, an antioxidant, an ultraviolet absorber, a coupling agent, a surfactant and the like, as needed. In addition, the epoxy resin composition may contain a toughness-imparting agent such as core-shell polymer particles, as needed.

The epoxy resin composition is a two-pack type composition composed of the epoxy base resin liquid which contains the component (A) in the above-described content ratio and the curing agent liquid which contains the component (B), and is used by mixing the epoxy base resin liquid and the curing agent liquid immediately before use such that the above-described content ratio is achieved. Meanwhile, the component (C) may be contained either in the epoxy base resin liquid or in the curing agent liquid, but it is preferable that the component (C) is contained in the curing agent liquid. It is preferable that both the epoxy base resin liquid and the curing agent liquid are separately warmed before being mixed, and it is preferable that the epoxy resin composition is obtained by mixing the epoxy base resin liquid and the curing agent liquid immediately before use such as the injection into a molding mold by using a mixer from the viewpoint of the usable time of the resin.

The epoxy resin composition preferably has a viscosity at 70° C. of 10 mPa·s or higher and 500 mPa·s or lower, and more preferably 10 mPa·s or higher and 250 mPa·s or lower. When the epoxy resin composition has a viscosity at 70° C. of 500 mPa·s or lower, impregnability into a reinforcing fiber tends to be excellent and, therefore, a high quality fiber-reinforced composite material is obtained. In addition, when the epoxy resin composition has a viscosity at 70° C. of 10 mPa·s or higher, a viscosity at a molding temperature tends not to be too low and, therefore, pit generation caused by sucking the air during the injection into a reinforcing fiber base can be suppressed, and then impregnation tends not to be ununiform. Meanwhile, a viscosity is defined to be a viscosity of an epoxy resin composition measured immediately after mixing two liquids, that is, an epoxy base resin liquid and a curing agent liquid.

The fiber-reinforced composite material obtained by using the epoxy resin composition can be suitably used for application to industrial materials, particularly to airplane and automobile materials. Examples of the method of molding the fiber-reinforced composite material include a hand lay-up method, a filament winding method, a pultrusion method, an RTM method and the like and, since these methods require the curing in a short period of time, the use of an epoxy resin composition having high-speed curability is required and, therefore, the epoxy resin composition is suitably used.

In addition, the curing time required to form the fiber-reinforced composite material depends on the gelation time of the epoxy resin composition used to form the fiber-reinforced composite material, and the shorter the gelation time of the epoxy resin composition is, the shorter the curing time required for formation of the fiber-reinforced composite material is. Accordingly, to improve productivity of the fiber-reinforced composite material, the epoxy resin composition preferably has a gelation time at a molding temperature of 5 minutes or shorter, and more preferably 4 minutes or shorter. In other words, the shorter the gelation time is, the better. As used herein, the gelation time can be measured in the following manner. Specifically, the gelation time is measured by a method comprising charging an epoxy resin composition obtained immediately after mixing two liquids, which are an epoxy base resin liquid and a curing agent liquid, as a sample into a die which has been heated to 180° C., loading torsional stress, and measuring an increase in viscosity of the sample accompanied by the progress in curing as a torque transmitted to the die by using a vulcanization/curing characteristics testing machine (for example, “Curelastometer” (registered trademark) type V manufactured by JSR trading Co., Ltd.). The gelation time is defined to be a time period required to achieve the torque of 0.001 N·m after initiation of the measurement. The molding temperature is appropriately regulated usually in a temperature range of 120° C. or higher and 200° C. or lower, depending on the kinds of the component (B) and the component (C) to be used. For example, when a mixture of diethyltoluenediamine, 4,4′-diaminodiphenyl sulfone and 3,3′-diaminodiphenyl sulfone is used as the component (B) and Bisphenol A is used as the component (C), the curing temperature is adjusted in a temperature range of 180° C. or higher and 200° C. or lower to make the gelation time 5 minutes or shorter.

Heat resistance of a fiber-reinforced composite material obtained by using an epoxy resin composition depends on the glass transition temperature of the cured product of the resin obtained by curing the epoxy resin composition and, therefore, to obtain a fiber-reinforced composite material having high heat resistance, the glass transition temperature of the cured product of the resin obtained by the complete curing of the epoxy resin composition achieved, for example, by heating the epoxy resin composition at a temperature of 180° C. for 2 hours or the like, is preferably 170° C. or higher and 250° C. or lower, and more preferably 180° C. or higher and 220° C. or lower. If a cured product of a resin has a glass transition temperature of lower than 170° C., the heat resistance may be insufficient. If a cured product of a resin has a glass transition temperature of higher than 250° C., the crosslinking density of a three-dimensional cross-linked structure becomes high, and the cured product of the resin tends to be fragile and, therefore, the tensile strength and impact resistance of the fiber-reinforced composite material may decrease. As used herein, a glass transition temperature of a cured product of a resin is determined according to a DMA measurement method. Meanwhile, the glass transition temperature is sometimes abbreviated as Tg.

The fiber-reinforced composite material is obtained by combining the two-pack type epoxy resin composition for the fiber-reinforced composite material with a reinforcing fiber and curing them. As the molding method to obtain the fiber-reinforced composite material, a molding method which uses a two-pack type resin such as a hand lay-up method, a filament winding method, a pultrusion method or an RTM method, is suitably used as described above. Among these methods, an RTM method is particularly suitably used from the viewpoint of productivity as well as the flexibility in the shape of the resulting molded product, and the like. The RTM method is a method of producing a reinforcing fiber composite material comprising injecting a resin into a molding mold in which a reinforcing fiber base has been placed and curing them to give the reinforcing fiber composite material.

Examples of the reinforcing fiber which can be used include a carbon fiber, a glass fiber, an aramid fiber, a boron fiber, a PBO fiber, a high tenacity polyethylene fiber, an alumina fiber, a silicon carbide fiber and the like. These fibers may be use as a mixture of 2 or more kinds of fibers. The arrangement and the form of the reinforcing fiber are not limited and, for example, long fibers aligned in one direction, a single tow as well as fiber structures (fiber bases) such as a woven fabric, a knitted article, a nonwoven fabric, a mat and a braid can be used.

In particular, in the application where high degrees of weight reduction and high strengthening of a material are required, a carbon fiber can be suitably used as the reinforcing fiber because the carbon fiber exhibits an excellent specific elastic modulus and an excellent specific strength.

When a carbon fiber is used as a reinforcing fiber, any kind of carbon fibers can be used depending on the intended use, but it is preferable to use a carbon fiber having a tensile elastic modulus of at most 400 GPa, and preferably from 230 to 400 GPa, from the viewpoint of the interlayer toughness and impact resistance. In addition, it is preferable to use a carbon fiber having a tensile strength of at least 4.4 GPa, and preferably from 4.4 to 6.5 GPa, from the viewpoint of obtaining a fiber-reinforced composite material having high stiffness and high mechanical strength. Further, a tensile elongation is also an important factor, and it is preferable to use a carbon fiber having a tensile elongation of at least 1.7%, and preferably from 1.7 to 2.3%. Accordingly, a carbon fiber having characteristics in which the tensile elastic modulus, the tensile strength and the tensile elongation fall within the above-described ranges is the most suitable.

Examples of commercially available products of a carbon fiber include “TORAYCA” (registered trademark) T800G-24K, “TORAYCA” (registered trademark) T800S-24K, “TORAYCA” (registered trademark) T700G-24K, “TORAYCA” (registered trademark) T300-3K, “TORAYCA” (registered trademark) T700S-12K (all of the above are manufactured by Toray Industries, Inc.), and the like.

For a fiber-reinforced composite material used in the field of airplanes, high heat resistance and high wet heat resistance as well as high mechanical properties such as high compressive strength are required. The fiber-reinforced composite material is usually capable of making the glass transition temperature of a matrix resin, which is the cured product of the epoxy resin, 170° C. or higher and 250° C. or lower and, therefore, the fiber-reinforced composite material is excellent in heat resistance and wet heat resistance. In addition, the compressive strength of the fiber-reinforced composite material depends on the generation amount of voids (air gaps), in the fiber-reinforced composite material, generated by volatilization of components in the epoxy resin composition and the like and, therefore, it is preferable that an indicator of the generation amount of voids, that is, a void fraction is less than 0.1%. As used herein, the void fraction of a fiber-reinforced composite material is the ratio expressed by the percentage of the area occupied by the parts of voids to the area of an arbitrary region, when a polished cut surface is observed by an optical microscope. As described above, the fiber-reinforced composite material having both a high heat resistance and a low void fraction has a high H/W 0° compressive strength, which is a compressive strength at 0° at moisture heat conditions and, for example, the fiber-reinforced composite material is capable of exhibiting a high H/W 0° compressive strength as high as 1100 MPa or higher.

### EXAMPLES

Hereinbelow, our compositions and materials will be described in more detail by way of examples.

### Resin Materials

To produce the resin compositions in Examples and Comparative Examples, the resin materials described below were used. The numerical value of each component shown in the column of each of the resin compositions in Tables 1 to 3 indicates the content ratio of the respective component, and unless otherwise specified, the unit used to express the content ratio is “parts by mass.”

1. Epoxy Resins Each of which is the Component (A)

“Araldite” (registered trademark) MY721 (manufactured by Huntsman Advanced Materials): tetraglycidyldiaminodiphenylmethane

“Araldite” (registered trademark) MY0600 (manufactured by Huntsman Advanced Materials): triglycidyl-m-aminophenol

2. Epoxy Resins Other than the Component (A)

“EPON” (registered trademark) 825 (manufactured by Mitsubishi Chemical Corporation): a bisphenol A-type epoxy resin (viscosity: 7000 mPa·s (25° C.))

“Celloxide” (registered trademark) 2021P (manufactured by Daicel Corporation): an alicyclic epoxy resin (viscosity: 350 mPa·s (25° C.))

3. Aromatic Amines Each of which is the Component (B)

“jERCURE” (registered trademark) W (manufactured by Mitsubishi Chemical Corporation): diethyltoluenediamine (viscosity: 160 mPa·s (25° C.))

“Kayahard” (registered trademark) A-A (manufactured by Nippon Kayaku Co., Ltd.): 2,2′-diethyl-4,4′-diaminodiphenylmethane (viscosity: 2000 mPa·s (25° C.))

“Lonzacure” (registered trademark) M-MIPA (manufactured by Lonza Japan): 3,3′-diisopropyl-5,5′-dimethyl-4,4′-diaminodiphenylmethane (viscosity: >1000 Pa·s (25° C.))

“Lonzacure” (registered trademark) M-DIPA (manufactured by Lonza Japan): 3,3′,5,5′-tetraisopropyl-4,4′-diaminodiphenylmethane (viscosity: >1000 Pa·s (25° C.))

### 4. Alicyclic Amine

“Ancamine” (registered trademark) 2049 (manufactured by Air Products and Chemicals, Inc.): 4,4′-methylenebis(2-methylcyclohexylamine) (viscosity: 120 mPa·s (25° C.))

5. Compounds Each of which is the Component (C) and Each Having at Least Two Aromatic Rings Each of which has a Phenolic Hydroxy Group

Bisphenol A (manufactured by KANTO CHEMICAL CO., INC.): 4,4′-isopropylidenediphenol (pKa: 10.2)

Bisphenol S (manufactured by KANTO CHEMICAL CO., INC.): 4,4′-sulfonyldiphenol (pKa: 7.8)

Phenol novolac resin: H-4 (manufactured by Meiwa Plastic Industries, Ltd.) (pKa: 9.8)

6. Phenol Compound Other than the Component (C)

4-tert-Butylcatechol: DIC-TBC (manufactured by DIC Corporation)

### 7. Acid Ester

p-Toluenesulfonic acid n-propyl ester (manufactured by Tokyo Chemical Industry Co., Ltd.) Preparation of epoxy resin composition

An epoxy resin such as a glycidylamine type epoxy resin, that is the component (A), was used for an epoxy base resin liquid, and an amine compound such as an aromatic amine, that is the component (B), as well as a phenol compound such as a compound having at least two aromatic rings each of which has a phenolic hydroxy group, that is the component (C), or an acid ester compound were used for a curing agent liquid, and they were mixed at each content ratio shown in any of Tables 1 to 3 to prepare an epoxy resin composition.

### Measurement of Viscosity

Viscosity of a sample to be measured was measured according to “Methods for measuring viscosity by a cone/plate rotational viscometer” prescribed in JIS Z8803 (1991) by using an E-type viscometer equipped with a standard cone rotor (1° 34′×R24), while keeping a temperature set to the measurement. As the E-type viscometer, TVE-30H manufactured by Tokimec Inc. was used. An epoxy resin composition obtained immediately after mixing two liquids, which were an epoxy base resin liquid and a curing agent liquid, was used as the sample.

### Measurement of Gelation Time

Gelation time was measured by a method comprising charging an epoxy resin composition obtained immediately after mixing two liquids, which were an epoxy base resin liquid and a curing agent liquid, as a sample into a die which had been heated to 180° C., loading torsional stress, and measuring an increase in viscosity of the sample accompanied by the progress in curing as a torque transmitted to the die by using a vulcanization/curing characteristics testing machine “Curelastometer” (registered trademark) type V manufactured by JSR trading Co., Ltd. The gelation time was defined to be a time period required for achieving a torque of 0.001 N·m after the initiation of the measurement.

Preparation of Cured Resin Plate

The epoxy resin composition prepared as described above was defoamed in a vacuum and, thereafter, the epoxy resin composition was injected into a mold in which the spaces were set to have a thickness of 2 mm by using spacers each having a thickness of 2 mm and being made of “Teflon” (registered trademark). The epoxy resin composition was heated at a temperature of 180° C. for two hours such that the composition was cured to give cured resin plates each having a thickness of 2 mm.

### Measurement of Glass Transition Temperature (Tg) of Cured Product of Resin

A test piece with a width of 12.7 mm and a length of 40 mm was cut out from a cured resin plate, and Tg was measured by using a DMA (ARES manufactured by TA Instruments Japan Inc.). The measurement condition was a temperature rising rate of 5° C./min. The inflection-point temperature of the storage elastic modulus G′ obtained by the measurement was taken as Tg.

### Preparation of Fiber-Reinforced Composite Material

A unidirectional fabric of carbon fibers (a plane weave structure; warp: a carbon fiber T800S-24K-10C manufactured by Toray Industries, Inc.; a weight per area of carbon fibers: 295 g/m²; a warp density: 7.2 threads/25 mm; woof: a glass fiber ECE225 1/0 1Z manufactured by Nitto Boseki Co., Ltd.; a woof density: 7.5 threads/25 mm) was cut out as a sheet with a size of 395 mm×395 mm, and 4 fabric sheets were laminated such that carbon fibers were aligned in a direction of 0° by setting the direction of carbon fibers as 0°. The laminated fabric sheets were set on a metallic mold having a plate-like cavity with a size of 400 mm×400 mm×1.2 mm, and then the mold clamping was performed. Subsequently, after the metallic mold was warmed to 80° C., an epoxy resin composition prepared in the above-described manner and which had been warmed to 80° C. beforehand was injected into the metallic mold by using a resin injector at an injection pressure of 0.2 MPa. After injecting the resin, the resin was subjected to a pre-curing step and, thereafter, an intermediate of a fiber-reinforced composite material was demolded. In the pre-curing step, the temperature of the metallic mold was raised to 130° C. at a temperature rising rate of 1.5° C./min, and then heated at 130° C. for 2 hours and, thereafter, the temperature was lowered to 30° C. Then, the demolded intermediate of the fiber-reinforced composite material was subjected to a post-curing step to obtain the fiber-reinforced composite material. In the post-curing step, the temperature of the fiber-reinforced composite material was raised from 30° C. to 180° C. at a temperature rising rate of 1.5° C./min, and the fiber-reinforced composite material heated at 180° C. for 2 hours and, thereafter, the temperature was lowered to 30° C. Measurement of H/W 0° compressive strength of fiber-reinforced composite material

From the fiber-reinforced composite material obtained in the above-described manner, a test piece for 0° compressive strength measurement with 79.4 mm length×12.7 mm width was cut out such that the length direction was the same as the 0° direction. The test piece was immersed in warm water at 72° C. for 14 days and, thereafter, the 0° compressive strength of the fiber-reinforced composite material was measured. The 0° compressive strength was measured according to ASTM D695 by using a universal materials testing machine (Instron model 4208 manufactured by Instron Japan) as a testing machine, with a crosshead speed at the measurement of 1.27 mm/min and with a measuring temperature of 82° C.

### Examples 1 to 5

Each epoxy resin composition with the content ratio shown in Table 1 was prepared in the above-described manner, and the viscosity at 70° C. and the gelation time were measured. In addition, a cured resin plate and a fiber-reinforced composite material were prepared by using each epoxy resin composition, and Tg, the void fraction and the H/W 0° compressive strength were measured. By adding 1 part by mass or more and 20 parts by mass or less of Bisphenol S, as the component (C), based on 100 parts by mass of the total of the epoxy resin in the epoxy base resin liquid, it became possible that the gelation time was reduced to 5 minutes or shorter. Further, Tg of the cured product of the resin was kept at 170° C. or higher, and both the high-speed curability and the heat resistance were good. Furthermore, with regard to the cured product of the resin, generation of voids was not observed and, therefore, the cured product of the resin having high surface quality was obtained. Also with regard to the fiber-reinforced composite material, the void fraction was less than 0.1%, the H/W 0° compressive strength was 1100 MPa or higher, and the fiber-reinforced composite material was good in all of the quality, the heat resistance and the mechanical properties.

### Examples 6 to 9

Each epoxy resin composition with the content ratio shown in Table 1 was prepared by changing the content ratios of MY721 and EPON825 in the epoxy base resin liquid of Example 2, and the viscosity at 70° C. and the gelation time were measured. In addition, a cured resin plate and a fiber-reinforced composite material were prepared by using each epoxy resin composition, and Tg, the void fraction and the H/W 0° compressive strength were measured. In the mass ratio, MY721/EPON825 was changed to 100/0 in Example 6, to 80/20 in Example 7, to 50/50 in Example 8 and to 30/70 in Example 9, but in each Example, the gelation time was 5 minutes or shorter. Further, Tg of the cured product of the resin was kept at 170° C. or higher, and both the high-speed curability and the heat resistance were good. Furthermore, with regard to the cured product of the resin, generation of voids was not observed and, therefore, the cured product of the resin having high surface quality was obtained. Also with regard to the fiber-reinforced composite material, the void fraction was less than 0.1%, the H/W 0° compressive strength was 1100 MPa or higher, and the fiber-reinforced composite material was good in all of the quality, the heat resistance and the mechanical properties.

### Example 10

An epoxy resin composition with the content ratio shown in Table 1 was prepared by using MY0600 instead of MY721 in the epoxy base resin liquid of Example 2, and the viscosity at 70° C. and the gelation time were measured. In addition, a cured resin plate and a fiber-reinforced composite material were prepared by using the epoxy resin composition, and Tg, the void fraction and the H/W 0° compressive strength were measured. The gelation time was 3.5 minutes. Further, Tg of the cured product of the resin was 182° C., and both the high-speed curability and the heat resistance were good. Furthermore, with regard to the cured product of the resin, generation of voids was not observed and, therefore, the cured product of the resin having high surface quality was obtained. Also, with regard to the fiber-reinforced composite material, the void fraction was less than 0.1%, the H/W 0° compressive strength was 1180 MPa, and the fiber-reinforced composite material was good in all of the quality, the heat resistance and the mechanical properties.

### Examples 11 to 13

Each epoxy resin composition with the content ratio shown in Table 1 was prepared by changing the content ratios of the liquid aromatic amine and the solid aromatic amine in the curing agent liquid of Example 2, and the viscosity at 70° C. and the gelation time were measured. In addition, a cured resin plate and a fiber-reinforced composite material were prepared by using each epoxy resin composition, and Tg, the void fraction and the H/W 0° compressive strength were measured. In the mass ratio, jERCURE W/(M-MIPA+M-DIPA) was changed to 100/0 in Example 11, to 80/20 in Example 12, and to 20/80 in Example 13, but in each Example, the gelation time was 5 minutes or shorter. Further, Tg of the cured product of the resin was kept at 170° C. or higher, and both the high-speed curability and the heat resistance were good. Furthermore, with regard to the cured product of the resin, generation of voids was not observed and, therefore, the cured product of the resin having high surface quality was obtained. Also, with regard to the fiber-reinforced composite material, the void fraction was less than 0.1%, the H/W 0° compressive strength was 1100 MPa or higher, and the fiber-reinforced composite material was good in all of the quality, the heat resistance and the mechanical properties.

### Example 14

An epoxy resin composition with the content ratio shown in Table 1 was prepared by using Ancamine 2049 which is a liquid alicyclic amine instead of jERCURE W in Example 2, and the viscosity at 70° C. and the gelation time were measured. In addition, a cured resin plate and a fiber-reinforced composite material were prepared by using the epoxy resin composition, and Tg, the void fraction and the H/W 0° compressive strength were measured. The gelation time was 3.3 minutes. Further, Tg of the cured product of the resin was 179° C., and both the high-speed curability and the heat resistance were good. Furthermore, with regard to the cured product of the resin, generation of voids was not observed and, therefore, the cured product of the resin having high surface quality was obtained. Also with regard to the fiber-reinforced composite material, the void fraction was less than 0.1%, the H/W 0° compressive strength was 1100 MPa, and the fiber-reinforced composite material was good in all of the quality, the heat resistance and the mechanical properties.

### Example 15

An epoxy resin composition with the content ratio shown in Table 2 was prepared by using Kayahard A-A as a liquid aromatic amine instead of jERCURE W in Example 2, and the viscosity at 70° C. and the gelation time were measured. In addition, a cured resin plate and a fiber-reinforced composite material were prepared by using the epoxy resin composition, and Tg, the void fraction and the H/W 0° compressive strength were measured. The gelation time was 4.5 minutes. Further, Tg of the cured product of the resin was 181° C., and both the high-speed curability and the heat resistance were good. Furthermore, with regard to the cured product of the resin, generation of voids was not observed and, therefore, the cured product of the resin having high surface quality was obtained. Also, with regard to the fiber-reinforced composite material, the void fraction was less than 0.1%, the H/W 0° compressive strength was 1120 MPa, and the fiber-reinforced composite material was good in all of the quality, the heat resistance and the mechanical properties.

### Examples 16 to 18

Each epoxy resin composition with the content ratio shown in Table 2 was prepared in the same manner as in Example 2, except that Bisphenol A was used as the component (C) instead of Bisphenol S and that the addition amount of the component (C) was changed, and the viscosity at 70° C. and the gelation time were measured. In addition, a cured resin plate and a fiber-reinforced composite material were prepared by using each epoxy resin composition, and Tg, the void fraction and the H/W 0° compressive strength were measured. By adding 3 parts by mass or more and 10 parts by mass or less of the component (C), based on 100 parts by mass of the total of the epoxy resin in the epoxy base resin liquid, it became possible that the gelation time was reduced to 5 minutes or shorter. Further, Tg of the cured product of the resin was kept at 170° C. or higher, and both the high-speed curability and the heat resistance were good. Furthermore, with regard to the cured product of the resin, generation of voids was not observed and, therefore, the cured product of the resin having high surface quality was obtained. Also, with regard to the fiber-reinforced composite material, the void fraction was less than 0.1%, the H/W 0° compressive strength was 1100 MPa or higher, and the fiber-reinforced composite material was good in all of the quality, the heat resistance and the mechanical properties.

### Example 19

An epoxy resin composition with the content ratio shown in Table 2 was prepared in the same manner as in Example 6, except that Bisphenol A was used as the component (C) instead of Bisphenol S and that the addition amount of the component (C) was changed to 20 parts by mass based on 100 parts by mass of the total of the epoxy resin in the epoxy base resin liquid, and the viscosity at 70° C. and the gelation time were measured. In addition, a cured resin plate and a fiber-reinforced composite material were prepared by using the epoxy resin composition, and Tg, the void fraction and the H/W 0° compressive strength were measured. The gelation time was 1.5 minutes. Further, Tg of the cured product of the resin was 175° C., and both the high-speed curability and the heat resistance were good. Furthermore, with regard to the cured product of the resin, generation of voids was not observed and, therefore, the cured product of the resin having high surface quality was obtained. Also with regard to the fiber-reinforced composite material, the void fraction was less than 0.1%, the H/W 0° compressive strength was 1140 MPa, and the fiber-reinforced composite material was good in all of the quality, the heat resistance and the mechanical properties.

### Examples 20 to 22

Each epoxy resin composition with the content ratio shown in Table 2 was prepared in the same manner as in Example 2, except that H-4 was used as the component (C) instead of Bisphenol S and that the addition amount of the component (C) was changed, and the viscosity at 70° C. and the gelation time were measured. In addition, a cured resin plate and a fiber-reinforced composite material were prepared by using each epoxy resin composition, and Tg, the void fraction and the H/W 0° compressive strength were measured. By adding 5 parts by mass or more and 15 parts by mass or less of the component (C), based on 100 parts by mass of the total of the epoxy resin in the epoxy base resin liquid, it became possible that the gelation time was reduced to 5 minutes or shorter. Further, Tg of the cured product of the resin was kept at 170° C. or higher, and both the high-speed curability and the heat resistance were good. Furthermore, with regard to the cured product of the resin, generation of voids was not observed and, therefore, the cured product of the resin having high surface quality was obtained. Also, with regard to the fiber-reinforced composite material, the void fraction was less than 0.1%, the H/W 0° compressive strength was 1100 MPa or higher, and the fiber-reinforced composite material was good in all of the quality, the heat resistance and the mechanical properties.

### Example 23

An epoxy resin composition with the content ratio shown in Table 2 was prepared in the same manner as in Example 6, except that H-4 was used as the component (C) instead of Bisphenol S and that the addition amount of the component (C) was changed to 20 parts by mass based on 100 parts by mass of the total of the epoxy resin in the epoxy base resin liquid, and the viscosity at 70° C. and the gelation time were measured. In addition, a cured resin plate and a fiber-reinforced composite material were prepared by using the epoxy resin composition, and Tg, the void fraction and the H/W 0° compressive strength were measured. The gelation time was 1.3 minutes. Further, Tg of the cured product of the resin was 176° C., and both the high-speed curability and the heat resistance were good. Furthermore, with regard to the cured product of the resin, generation of voids was not observed and, therefore, the cured product of the resin having high surface quality was obtained. Also, with regard to the fiber-reinforced composite material, the void fraction was less than 0.1%, the H/W 0° compressive strength was 1150 MPa, and the fiber-reinforced composite material was good in all of the quality, the heat resistance and the mechanical properties.

### Comparative Example 1

An epoxy resin composition with the content ratio shown in Table 3 was prepared in the same manner as in Example 2, except that no component (C) was added, and the viscosity at 70° C. and the gelation time were measured. In addition, a cured resin plate and a fiber-reinforced composite material were prepared by using the epoxy resin composition, and Tg, the void fraction and the H/W 0° compressive strength were measured. The gelation time was 8.3 minutes and Tg of the cured product of the resin was 190° C. Although the heat resistance was good, the curability was lower as compared to the Examples. Accordingly, the result that both the high-speed curability and the high heat resistance were satisfied could not be obtained. In addition, with regard to the fiber-reinforced composite material, the void fraction was less than 0.1%, the H/W 0° compressive strength was 1260 MPa, and the fiber-reinforced composite material was good in all of the quality, the heat resistance and the mechanical properties.

### Comparative Examples 2 to 4

Each epoxy resin composition with the content ratio shown in Table 3 was prepared in the same manner as in Example 2, except that 4-tert-butylcatechol was used instead of Bisphenol S, which is the component (C), and that the addition amount of 4-tert-butylcatechol was changed, and the viscosity at 70° C. and the gelation time were measured. In addition, a cured resin plate and a fiber-reinforced composite material were prepared by using each epoxy resin composition, and Tg, the void fraction and the H/W 0° compressive strength were measured. Although 1 part by mass or more and 5 parts by mass or less of 4-tert-butylcatechol was added, based on 100 parts by mass of the total of the epoxy resin in each epoxy base resin liquid, the gelation time could not be reduced to 5 minutes or shorter and Tg of the cured product of the resin could not be kept at 170° C. or higher. Accordingly, the result that both the high-speed curability and the high heat resistance were satisfied could not be obtained. Further, volatilization of a component(s) was observed during the heat curing, and deterioration of the surface quality of the cured product of the resin caused by voids was partly observed. Also, with regard to the fiber-reinforced composite material, the void fraction was 0.1% or more, the H/W 0° compressive strength was lower than 1100 MPa, and the result that all of the high quality, the high heat resistance and the good mechanical properties were satisfied could not be obtained.

### Comparative Examples 5 to 7

Each epoxy resin composition with the content ratio shown in Table 3 was prepared in the same manner as in Example 2, except that p-toluenesulfonic acid propyl ester was used instead of Bisphenol S, which is the component (C), and that the addition amount of p-toluenesulfonic acid propyl ester was changed, and the viscosity at 70° C. and the gelation time were measured. In addition, a cured resin plate and a fiber-reinforced composite material were prepared by using each epoxy resin composition, and Tg, the void fraction and the H/W 0° compressive strength were measured. Although 1 part by mass or more and 5 parts by mass or less of p-toluenesulfonic acid propyl ester was added, based on 100 parts by mass of the total of the epoxy resin in each epoxy base resin liquid, the gelation time could not be reduced to 5 minutes or shorter and Tg of the cured product of the resin could not be kept at 170° C. or higher. Accordingly, the result that both the high-speed curability and the high heat resistance were satisfied could not be obtained. Further, volatilization of a component(s) was observed during the heat curing, and deterioration of the surface quality of the cured product of the resin caused by voids was partly observed. Also, with regard to the fiber-reinforced composite material, the void fraction was 0.1% or more, the H/W 0° compressive strength was lower than 1100 MP, and the result that all of the high quality, the high heat resistance and the good mechanical properties were satisfied could not be obtained.

### Comparative Examples 8 and 9

Each epoxy resin composition with the content ratio shown in Table 3 was prepared by changing the content ratios of MY721 and EPON825 in the epoxy base resin liquid of Example 2, and the viscosity at 70° C. and the gelation time were measured. In addition, a cured resin plate and a fiber-reinforced composite material were prepared by using each epoxy resin composition, and Tg, the void fraction and the H/W 0° compressive strength were measured. In the mass ratio, MY721/EPON825 was changed to 20/80 in Comparative Example 8, and was changed to 0/100 in Comparative Example 9, but in each case, the gelation time could not be reduced to 5 minutes or shorter and Tg of the cured product of the resin could not be kept at 170° C. or higher. Accordingly, the result that both the high-speed curability and the high heat resistance were satisfied could not be obtained. Further, no voids were generated in the cured product of the resin, and the cured product of the resin having high surface quality was obtained. However, with regard to the fiber-reinforced composite material, the void fraction was less than 0.1%, but the H/W 0° compressive strength was lower than 1100 MPa, and the result that all of the high quality, the high heat resistance and the good mechanical properties were satisfied could not be obtained.

### Comparative Example 10

An epoxy resin composition with the content ratio shown in Table 3 was prepared by changing EPON825 in the epoxy base resin liquid of Comparative Example 8 to Celloxide 2021P, and the viscosity at 70° C. and the gelation time were measured. In addition, a cured resin plate and a fiber-reinforced composite material were prepared by using the epoxy resin composition, and Tg, the void fraction and the H/W 0° compressive strength were measured. The gelation time was longer than 10 minutes and Tg of the cured product of the resin was 151° C. As compared to the Examples, both the curing-speed and the heat resistance were low and satisfactory results could not be obtained. Further, no voids were generated in the cured product of the resin, and the cured product of the resin having high surface quality was obtained. However, with regard to the fiber-reinforced composite material, the void fraction was less than 0.1%, but the H/W 0° compressive strength was 750 MPa, and the result that all of the high quality, the high heat resistance and the good mechanical properties were satisfied could not be obtained.

### Comparative Example 11

An epoxy resin composition with the content ratio shown in Table 3 was prepared by using Ancamine 2049, which is an alicyclic amine, instead of the aromatic amine in the curing agent liquid of Example 2, and the viscosity at 70° C. and the gelation time were measured. In addition, a cured resin plate and a fiber-reinforced composite material were prepared by using the epoxy resin composition, and Tg, the void fraction and the H/W 0° compressive strength were measured. The gelation time was 2.0 minutes and Tg of the cured product of the resin was 168° C. Although the high-speed curability was achieved, the heat resistance was lower than the Examples, and the result that both the high-speed curability and the high heat resistance were satisfied could not be obtained. Further, no voids were generated in the cured product of the resin, and the cured product of the resin having high surface quality was obtained. However, with regard to the fiber-reinforced composite material, the void fraction was less than 0.1%, but the H/W 0° compressive strength was 800 MPa, and the result that all of the high quality, the high heat resistance and the good mechanical properties were satisfied could not be obtained.

### Comparative Example 12

An epoxy resin composition with the content ratio shown in Table 3 was produced by using only Lonzacure M-MIPA and Lonzacure M-DIPA, both of which are solid aromatic amines, as the curing agent instead of that of Example 2, and compounding the epoxy resin, the curing agent and Bisphenol S, which is the component (C), as a one-pack type liquid composition, and the viscosity at 70° C. and the gelation time were measured. In addition, a cured resin plate and a fiber-reinforced composite material were produced by using the epoxy resin composition, and Tg, the void fraction and the H/W 0° compressive strength were measured. The gelation time was longer than 10 minutes and Tg of the cured product of the resin was 190° C. Although the heat resistance was good, the curability was lower than the Examples, and the result that both the high-speed curability and the high heat resistance were satisfied could not be obtained. Further, the viscosity of the resin at 70° C. was 1000 mPa·s, which was higher than the Examples, and there were some cases where the impregnability into the reinforcing fiber was inferior. Furthermore, with regard to the cured product of the resin, no voids were generated in the cured product of the resin, and the cured product of the resin having high surface quality was obtained. However, with regard to the fiber-reinforced composite material, the void fraction was less than 0.1%, but the H/W 0° compressive strength was 1090 MPa, and the result that all of the high quality, the high heat resistance and the good mechanical properties were satisfied could not be obtained.

As described above, the two-pack type epoxy resin composition for our fiber-reinforced composite material is excellent both in the high-speed curability and the heat resistance and, therefore, makes it possible to obtain a fiber-reinforced composite material with high performance in a short period of time and with good productivity, for example, by an RTM method. In addition, the two-pack type epoxy resin composition for the fiber-reinforced composite material is also excellent for molding a fiber-reinforced composite material having a large size, and is particularly suitable for the application to members for airplanes and automobiles.

TABLE 1

| | | | | Exam- | Exam- | Exam- | Exam- | Exam- | Exam- | Exam- | Exam- |
|---|---|---|---|---|---|---|---|---|---|---|---|
| | | | | ple | ple | ple | ple | ple | ple | ple | ple |
| | | | | 1 | 2 | 3 | 4 | 5 | 6 | 7 | 8 |
| Epoxy resin | Component (A) | | MY721 | 60 | 60 | 60 | 60 | 60 | 100 | 80 | 50 |
| Composition | Glycidylamine | | MY0600 | 0 | 0 | 0 | 0 | 0 | 0 | 0 | 0 |
| | type epoxy resins | | | | | | | | | | |
| | Epoxy resins other | | EPON825 | 40 | 40 | 40 | 40 | 40 | 0 | 20 | 50 |
| | than Component (A) | | Celloxide | 0 | 0 | 0 | 0 | 0 | 0 | 0 | 0 |
| | | | 2021P | | | | | | | | |
| | Component (B) | Liquid | jERCURE W | 25.1 | 25.1 | 25.1 | 25.1 | 25.1 | 29.4 | 27.1 | 24.1 |
| | Aromatic | | Kayahard A-A | — | — | — | — | — | — | — | — |
| | Amines | Solid | Lonzacure | 8.3 | 8.3 | 8.3 | 8.3 | 8.3 | 9.8 | 9.1 | 8.0 |
| | | | M-MIPA | | | | | | | | |
| | | | Lonzacure | 8.3 | 8.3 | 8.3 | 8.3 | 8.3 | 9.8 | 9.1 | 8.0 |
| | | | M-DIPA | | | | | | | | |

| | | | | | | | | | |
|---|---|---|---|---|---|---|---|---|---|
| Alicyclic amine | Ancamine | — | — | — | — | — | — | — | — |
| | 2049 | | | | | | | | |
| Component (C) | Bisphenol S | 1 | 3 | 5 | 7 | 20 | 3 | 3 | 3 |
| Compounds having | Bisphenol A | — | — | — | — | — | — | — | — |
| at least two | H-4 | — | — | — | — | — | — | — | — |
| aromatic rings | | | | | | | | | |
| having phenolic | | | | | | | | | |
| hydroxy groups | | | | | | | | | |
| Phenol compound | 4-tert- | — | — | — | — | — | — | — | — |
| other than | Butylcatechol | | | | | | | | |
| Component (C) | | | | | | | | | |
| Acid ester | p-Toluene- | — | — | — | — | — | — | — | — |
| | sulfonic acid | | | | | | | | |
| | propyl ester | | | | | | | | |

| | | | | | | | | | |
|---|---|---|---|---|---|---|---|---|---|
| | H/E ratio | 1.0 | 1.0 | 1.0 | 1.0 | 1.0 | 1.0 | 1.0 | 1.0 |
| Characteristics of | Viscosity at 70° C. | 236 | 240 | 244 | 248 | 274 | 280 | 260 | 230 |
| uncured resin | [mPa · s] | | | | | | | | |
| | Gelation time | 4.9 | 3.8 | 2.8 | 1.8 | 0.8 | 4.1 | 3.9 | 3.7 |
| | [min] | | | | | | | | |
| Characteristics | Glass transition | 188 | 186 | 184 | 180 | 172 | 206 | 190 | 184 |
| of cured product | temperature [° C.] | | | | | | | | |
| of resin | | | | | | | | | |
| Characteristics | Void fraction [%] | <0.1 | <0.1 | <0.1 | <0.1 | <0.1 | <0.1 | <0.1 | <0.1 |
| of fiber- | H/W 0° compressive | 1250 | 1230 | 1210 | 1170 | 1100 | 1270 | 1260 | 1200 |
| reinforced | strength [MPa] | | | | | | | | |
| composite | | | | | | | | | |
| material | | | | | | | | | |

| | | | Exam- | Exam- | Exam- | Exam- | Exam- | Exam- |
|---|---|---|---|---|---|---|---|---|
| | | | ple | ple | ple | ple | ple | ple |
| | | | 9 | 10 | 11 | 12 | 13 | 14 |
| Epoxy resin | Component (A) | MY721 | 30 | 0 | 60 | 60 | 60 | 60 |
| Composition | Glycidylamine | MY0600 | 0 | 60 | 0 | 0 | 0 | 0 |
| | type epoxy resins | | | | | | | |
| | Epoxy resins other | EPON825 | 70 | 40 | 40 | 40 | 40 | 40 |
| | than Component (A) | Celloxide | 0 | 0 | 0 | 0 | 0 | 0 |
| | | 2021P | | | | | | |

| | | | | | | | | |
|---|---|---|---|---|---|---|---|---|
| Component (B) | Liquid | jERCURE W | 22.3 | 24.5 | 34.2 | 30.2 | 10.9 | — |
| Aromatic | | Kayahard A-A | — | — | — | — | — | — |
| Amines | Solid | Lonzacure | 7.4 | 8.2 | — | 3.8 | 21.9 | 10.3 |
| | | M-MIPA | | | | | | |
| | | Lonzacure | 7.4 | 8.2 | — | 3.8 | 21.9 | 10.3 |
| | | M-DIPA | | | | | | |

| | | | | | | | |
|---|---|---|---|---|---|---|---|
| Alicyclic amine | Ancamine | — | — | — | — | — | 23.2 |
| | 2049 | | | | | | |
| Component (C) | Bisphenol S | 3 | 3 | 3 | 3 | 3 | 3 |
| Compounds having | Bisphenol A | — | — | — | — | — | — |
| at least two | H-4 | — | — | — | — | — | — |
| aromatic rings | | | | | | | |
| having phenolic | | | | | | | |
| hydroxy groups | | | | | | | |
| Phenol compound | 4-tert- | — | — | — | — | — | — |
| other than | Butylcatechol | | | | | | |
| Component (C) | | | | | | | |
| Acid ester | p-Toluene- | — | — | — | — | — | — |
| | sulfonic acid | | | | | | |
| | propyl ester | | | | | | |

| | | | | | | | |
|---|---|---|---|---|---|---|---|
| | H/E ratio | 1.0 | 1.0 | 1.0 | 1.0 | 1.0 | 1.0 |
| Characteristics of | Viscosity at 70° C. | 210 | 220 | 200 | 220 | 350 | 200 |
| uncured resin | [mPa · s] | | | | | | |
| | Gelation time | 3.5 | 3.5 | 2.5 | 3.0 | 4.9 | 3.3 |
| | [min] | | | | | | |
| Characteristics | Glass transition | 174 | 182 | 170 | 178 | 188 | 179 |
| of cured product | temperature [° C.] | | | | | | |
| of resin | | | | | | | |
| Characteristics | Void fraction [%] | <0.1 | <0.1 | <0.1 | <0.1 | <0.1 | <0.1 |
| of fiber- | H/W 0° compressive | 1100 | 1180 | 1150 | 1200 | 1200 | 1100 |
| reinforced | strength [MPa] | | | | | | |
| composite | | | | | | | |
| material | | | | | | | |

TABLE 2

| | | | | Exam- | Exam- | Exam- | Exam- | Exam- | Exam- | Exam- | Exam- | Exam- |
|---|---|---|---|---|---|---|---|---|---|---|---|---|
| | | | | ple | ple | ple | ple | ple | ple | ple | ple | ple |
| | | | | 15 | 16 | 17 | 18 | 19 | 20 | 21 | 22 | 23 |
| Epoxy resin | Component (A) | | MY721 | 60 | 60 | 60 | 60 | 100 | 60 | 60 | 60 | 100 |
| Composition | Glycidylamine type | | MY0600 | 0 | 0 | 0 | 0 | 0 | 0 | 0 | 0 | 0 |
| | epoxy resins | | | | | | | | | | | |
| | Epoxy resins other | | EPON825 | 40 | 40 | 40 | 40 | 0 | 40 | 40 | 40 | 0 |
| | than Component (A) | | Celloxide | 0 | 0 | 0 | 0 | 0 | 0 | 0 | 0 | 0 |
| | | | 2021P | | | | | | | | | |
| | Component (B) | Liquid | jERCURE W | 0 | 25.1 | 25.1 | 25.1 | 29.4 | 25.1 | 25.1 | 25.1 | 29.4 |
| | Aromatic | | Kayahard A-A | 31.9 | — | — | — | — | — | — | — | — |
| | amines | Solid | Lonzacure | 10.6 | 8.3 | 8.3 | 8.3 | 9.8 | 8.3 | 8.3 | 8.3 | 9.8 |
| | | | M-MIPA | | | | | | | | | |
| | | | Lonzacure | 10.6 | 8.3 | 8.3 | 8.3 | 9.8 | 8.3 | 8.3 | 8.3 | 9.8 |
| | | | M-DIPA | | | | | | | | | |

| | | | | | | | | | | |
|---|---|---|---|---|---|---|---|---|---|---|
| Alicyclic amine | Ancamine | — | — | — | — | — | — | — | — | — |
| | 2049 | | | | | | | | | |
| Component (C) | Bisphenol S | 3 | — | — | — | — | — | — | — | — |
| Compounds having at | Bisphenol A | — | 3 | 5 | 10 | 20 | — | — | — | — |
| least two aromatic | H-4 | — | — | — | — | — | 5 | 10 | 15 | 20 |
| rings having phenolic | | | | | | | | | | |
| hydroxy groups | | | | | | | | | | |
| Phenol compound other | 4-tert- | — | — | — | — | — | — | — | — | — |
| than Component (C) | Butylcatechol | | | | | | | | | |
| Acid ester | p-Toluene- | — | — | — | — | — | — | — | — | — |
| | sulfonic acid | | | | | | | | | |
| | propyl ester | | | | | | | | | |

| | | | | | | | | | | |
|---|---|---|---|---|---|---|---|---|---|---|
| | H/E ratio | 1.0 | 1.0 | 1.0 | 1.0 | 1.0 | 1.0 | 1.0 | 1.0 | 1.0 |
| Characteristics of | Viscosity at 70° C. | 290 | 242 | 244 | 249 | 410 | 242 | 253 | 263 | 400 |
| uncured resin | [mPa · s] | | | | | | | | | |
| | Gelation time | 4.5 | 4.0 | 3.5 | 2.2 | 1.5 | 3.4 | 2.0 | 1.4 | 1.3 |
| | [min] | | | | | | | | | |
| Characteristics | Glass transition | 181 | 181 | 178 | 172 | 175 | 183 | 177 | 171 | 176 |
| of cured product | temperature [° C.] | | | | | | | | | |
| of resin | | | | | | | | | | |
| Characteristics | Void fraction [%] | <0.1 | <0.1 | <0.1 | <0.1 | <0.1 | <0.1 | <0.1 | <0.1 | <0.1 |
| of fiber- | H/W 0° compressive | 1120 | 1170 | 1140 | 1100 | 1140 | 1190 | 1130 | 1100 | 1150 |
| reinforced | strength [MPa] | | | | | | | | | |
| composite | | | | | | | | | | |
| material | | | | | | | | | | |

TABLE 3

| | | | | Compar- | Compar- | Compar- | Compar- | Compar- | Compar- | Compar- |
|---|---|---|---|---|---|---|---|---|---|---|
| | | | | ative | ative | ative | ative | ative | ative | ative |
| | | | | Exam- | Exam- | Exam- | Exam- | Exam- | Exam- | Exam- |
| | | | | ple 1 | ple 2 | ple 3 | ple 4 | ple 5 | ple 6 | ple 7 |
| Epoxy resin | Component (A) | | MY721 | 60 | 60 | 60 | 60 | 60 | 60 | 60 |
| composition | Glycidylamine | | MY0600 | 0 | 0 | 0 | 0 | 0 | 0 | 0 |
| | type epoxy resins | | | | | | | | | |
| | Epoxy resins other | | EPON825 | 40 | 40 | 40 | 40 | 40 | 40 | 40 |
| | than Component (A) | | Celloxide | 0 | 0 | 0 | 0 | 0 | 0 | 0 |
| | | | 2021P | | | | | | | |
| | Component (B) | Liquid | jERCURE W | 25.1 | 25.1 | 25.1 | 25.1 | 25.1 | 25.1 | 25.1 |
| | Aromatic | | Kayahard A-A | — | — | — | — | — | — | — |
| | Amines | Solid | Lonzacure | 8.3 | 8.3 | 8.3 | 8.3 | 8.3 | 8.3 | 8.3 |
| | | | M-MIPA | | | | | | | |
| | | | Lonzacure | 8.3 | 8.3 | 8.3 | 8.3 | 8.3 | 8.3 | 8.3 |
| | | | M-DIPA | | | | | | | |

| | | | | | | | | |
|---|---|---|---|---|---|---|---|---|
| Alicyclic amine | Ancamine | — | — | — | — | — | — | — |
| | 2049 | | | | | | | |
| Component (C) | Bisphenol S | — | — | — | — | — | — | — |
| Compounds having | Bisphenol A | — | — | — | — | — | — | — |
| at least two | H-4 | — | — | — | — | — | — | — |
| aromatic rings | | | | | | | | |
| having phenolic | | | | | | | | |
| hydroxy groups | | | | | | | | |
| Phenol compound | 4-tert- | — | 1 | 3 | 5 | — | — | — |
| other than | utylcatechol | | | | | | | |
| Component (C) | | | | | | | | |
| Acid ester | p-Toluene | — | — | — | — | 1 | 3 | 5 |
| | sulfonic acid | | | | | | | |
| | propyl ester | | | | | | | |

| | | | | | | | | |
|---|---|---|---|---|---|---|---|---|
| | H/E ratio | 1.0 | 1.0 | 1.0 | 1.0 | 1.0 | 1.0 | 1.0 |
| Characteristics of | Viscosity at 70° C. | 235 | 236 | 238 | 240 | 235 | 236 | 238 |
| uncured resin | [mPa · s] | | | | | | | |
| | Gelation time | 8.3 | 6.3 | 5.1 | 4.1 | 5.5 | 3.2 | 1.7 |
| | [min] | | | | | | | |
| Characteristics | Glass transition | 190 | 187 | 178 | 169 | 183 | 169 | 158 |
| of cured product | temperature [° C.] | | | | | | | |
| of resin | | | | | | | | |
| Characteristics | Void fraction [%] | <0.1 | 0.1 | 0.2 | 0.5 | 0.1 | 0.2 | 0.5 |
| of fiber- | H/W 0° compressive | 1260 | 1090 | 1020 | 900 | 1080 | 990 | 850 |
| reinforced | strength [MPa] | | | | | | | |
| composite | | | | | | | | |
| material | | | | | | | | |

| | | | Compar- | Compar- | Compar- | Compar- | Compar- |
|---|---|---|---|---|---|---|---|
| | | | ative | ative | ative | ative | ative |
| | | | Exam- | Exam- | Exam- | Exam- | Exam- |
| | | | ple 8 | ple 9 | ple 10 | ple 11 | ple 12 |
| Epoxy resin | Component (A) | MY721 | 20 | 0 | 20 | 60 | 60 |
| composition | Glycidylamine | MY0600 | 0 | 0 | 0 | 0 | 0 |
| | type epoxy resins | | | | | | |
| | Epoxy resins other | EPON825 | 80 | 100 | 0 | 40 | 40 |
| | than Component (A) | Celloxide | 0 | 0 | 80 | 0 | 0 |
| | | 2021P | | | | | |

| | | | | | | | |
|---|---|---|---|---|---|---|---|
| Component (B) | Liquid | jERCURE W | 21.2 | 18.9 | 25.5 | 0 | 0 |
| Aromatic | | Kayahard A-A | — | — | — | — | — |
| Amines | Solid | Lonzacure | 7.1 | 6.3 | 8.5 | — | 32.2 |
| | | M-MIPA | | | | | |
| | | Lonzacure | 7.1 | 6.3 | 8.5 | — | 32.2 |
| | | M-DIPA | | | | | |

| | | | | | | |
|---|---|---|---|---|---|---|
| Alicyclic amine | Ancamine | — | — | — | 45.6 | — |
| | 2049 | | | | | |
| Component (C) | Bisphenol S | 3 | 3 | 3 | 3 | 3 |
| Compounds having | Bisphenol A | — | — | — | — | — |
| at least two | H-4 | — | — | — | — | — |
| aromatic rings | | | | | | |
| having phenolic | | | | | | |
| hydroxy groups | | | | | | |
| Phenol compound | 4-tert- | — | — | — | — | — |
| other than | utylcatechol | | | | | |
| Component (C) | | | | | | |
| Acid ester | p-Toluene | — | — | — | — | — |
| | sulfonic acid | | | | | |
| | propyl ester | | | | | |

| | | | | | | |
|---|---|---|---|---|---|---|
| | H/E ratio | 1.0 | 1.0 | 1.0 | 1.0 | 1.0 |
| Characteristics of | Viscosity at 70° C. | 198 | 178 | 90 | 200 | 1000 |
| uncured resin | [mPa · s] | | | | | |
| | Gelation time | 3.4 | 3.2 | >10 | 2.0 | >10 |
| | [min] | | | | | |
| Characteristics | Glass transition | 169 | 160 | 151 | 163 | 190 |
| of cured product | temperature [° C.] | | | | | |
| of resin | | | | | | |
| Characteristics | Void fraction [%] | <0.1 | <0.1 | <0.1 | <0.1 | <0.1 |
| of fiber- | H/W 0° compressive | 950 | 800 | 750 | 800 | 1090 |
| reinforced | strength [MPa] | | | | | |
| composite | | | | | | |
| material | | | | | | |

### INDUSTRIAL APPLICABILITY

Our two-pack type epoxy resin composition for the fiber-reinforced composite material is excellent in high-speed curability and high heat resistance and, therefore, makes it possible to provide a fiber-reinforced composite material with high quality with good productivity, for example, by an RTM method. Accordingly, the progress of the application of the fiber-reinforced composite material to the use particularly in airplanes and automobiles as well as the contribution to the improvement of the fuel consumption and the reduction in global warming gas emissions by further lightening of weight can be expected.

1-13. (canceled)

14. A two-pack type epoxy resin composition for a fiber-reinforced composite material, comprising components (A) to (C) below, the epoxy resin composition comprising:
an epoxy base resin liquid comprising 30 mass % or more and 100 mass % or less of a component (A); and
a curing agent liquid comprising a component (B),
wherein,
the component (A) is a glycidylamine type epoxy resin;
the component (B) is an aromatic amine; and
the component (C) is a compound having at least two aromatic rings each of which has a phenolic hydroxy group.

15. The two-pack type epoxy resin composition according to claim 14, wherein the component (A) is a tri- or higher functional glycidylamine type epoxy resin.

16. The two-pack type epoxy resin composition according to claim 14, wherein the component (A) is a glycidylamine type epoxy resin selected from N,N,N′,N′-tetraglycidyldiaminodiphenylmethane, triglycidylaminophenol, or a derivative thereof or an isomer thereof.

17. The two-pack type epoxy resin composition according to claim 14, wherein the epoxy base resin liquid contains a liquid bisphenol-type epoxy resin.

18. The two-pack type epoxy resin composition according to claim 14, wherein the curing agent liquid contains a liquid amine.

19. The two-pack type epoxy resin composition according to claim 14, wherein the component (B) is a mixture of a liquid aromatic amine and a solid aromatic amine.

20. The two-pack type epoxy resin composition according to claim 14, wherein the component (C) is a bisphenol compound containing at least two phenolic hydroxy groups.

21. The two-pack type epoxy resin composition according to claim 14, wherein the component (C) has an acid dissociation constant (pKa) of 7 or more and 9.8 or less.

22. The two-pack type epoxy resin composition according to claim 14, containing 1 part by mass or more and 20 parts by mass or less of the component (C) based on 100 parts by mass of a total of the epoxy resin contained in the epoxy base resin liquid.

23. The two-pack type epoxy resin composition according to claim 14, having a viscosity at 70° C. measured using an E-type viscometer of 10 mPa·s or higher and 500 mPa·s or lower.

24. The two-pack type epoxy resin composition according to claim 14, which is used for an RTM method.

25. A fiber-reinforced composite material obtained by combining the two-pack type epoxy resin composition according to claim 14 with a reinforcing fiber and curing them.

26. The fiber-reinforced composite material according to claim 25, wherein the reinforcing fiber is a carbon fiber.
